(19) United States
(12) Patent Application Publication
(10) Pub. No.: US 2012/0111131 A1
(43) Pub. Date: May 10, 2012

(54) VEHICLE GEARBOX FAMILY

(75) Inventor: Rene Scheucher, Gnas (AT)

(73) Assignee: MAGNA Powertrain AG & Co KG, Lannach (AT)

(21) Appl. No.: 13/380,551

(22) PCT Filed: Jun. 7, 2010
(86) PCT No.: PCT/EP2010/057910

§ 371 Date: Jan. 23, 2012

(30) Foreign Application Priority Data
Jun. 23, 2009 (DE) 102009030027.9

(51) Int. Cl. F16H 27/04

(52) U.S. Cl. 74/25

(57) ABSTRACT

A family of vehicle gearboxes having at least a first vehicle gearbox and a second vehicle gearbox, such that the first and the second vehicle gearbox are of modular construction and have an actuation system which is substantially structurally identical. The actuation system is provided in the first vehicle gearbox for actuating a parking lock and in the second vehicle gearbox for actuating a functional unit which differs from the parking lock, in particular, a clutch.

### CROSS-REFERENCE TO RELATED APPLICATIONS

The present application is a National Stage Application of PCT International Application No. PCT/EP2010/057910 (filed on Jun. 7, 2010), under 35 U.S.C. §371, which claims priority to German Patent Application No. 10 2009 030 027.9 (filed on Jun. 23, 2009), which are each hereby incorporated by reference in their respective entireties.

### FIELD OF THE INVENTION

The present invention relates to a family of vehicle gearboxes having at least a first vehicle gearbox and a second vehicle gearbox.

### BACKGROUND OF THE INVENTION

Owing to the considerable cost pressure in automotive engineering, it is becoming ever more important for the components of a vehicle to be designed to be as versatile as possible or such that they can be adapted to the respective requirement specifications with minor modifications.

### SUMMARY OF THE INVENTION

It is, therefore, an object of the present invention to create a family of vehicle gearboxes, the family members of which are as versatile as possible without requiring significant structural modifications.

The above object is achieved by way of a family of vehicle gearboxes having at least the features set forth in the claims.

The vehicle gearbox family in accordance with the invention is characterized in that a first vehicle gearbox and a second vehicle gearbox are of modular construction, each such vehicle gearboxe having an actuation system which is substantially structurally identical. The actuation system is provided in the first vehicle gearbox for actuating a parking lock and in the second vehicle gearbox for actuating a functional unit which differs from the parking lock, in particular a clutch.

Through the use of a substantially structurally identical actuation system, standardization is achieved which, owing solely to the higher numbers in which the individual components are produced, yields tower costs, and therefore, competitive advantages. To convert a vehicle gearbox of the vehicle gearbox family in accordance with the invention for another application, it is furthermore necessary merely to exchange the functional unit connected to the actuation system, and not additionally the actuation system itself. It is, therefore, easily possible to react to fluctuations in demand for individual members of the vehicle gearbox family.

Further embodiments of the invention are specified in the description, the drawings and the subclaims.

In one advantageous embodiment of the present invention, an output element of the actuation system is designed so as to be compatible with an actuation input element of the parking lock and an actuation input element of the functional unit which differs from the parking lock. A further cost reduction is attained as a result of the standardization of the “interface” between the actuation system and the parking lock/functional unit to be actuated.

It may be provided that the actuation system is arranged at the same position relative to at least one predetermined component of the vehicle gearbox in the first vehicle gearbox and in the second vehicle gearbox. The position of the actuation system is to be understood to mean the general position thereof in space, defined in relation to a predetermined component. Such a component may be, for example, a gearbox shaft or a particular gearbox gearwheel. The position of the actuation system may also be defined in relation to the housing or particular housing portions. This measure serves to provide further standardization, and therefore, increases the flexibility with which the members of the vehicle gearbox family can be used.

It is preferable for the first vehicle gearbox and the second vehicle gearbox to include a gearbox shaft, and for the actuation system to include an actuator shaft. A spacing between the gearbox shaft and the actuator shaft is identical in both vehicle gearboxes. In particular, the gearbox shaft and the actuator shaft are arranged offset with respect to and parallel to one another.

### BRIEF DESCRIPTION OF THE DRAWINGS

The invention is described in more detail in the enclosed figures and drawings, which present an implementation example. The drawings demonstrate:

FIG. 1 illustrates an actuation system of a first vehicle gearbox in a family of vehicle gearboxes in accordance with the invention, in conjunction with a parking lock.

FIG. 2 illustrates an actuation system of a second vehicle gearbox in a family of vehicle gearboxes in accordance with the invention, in conjunction with a clutch.

### DETAILED DESCRIPTION OF EMBODIMENTS

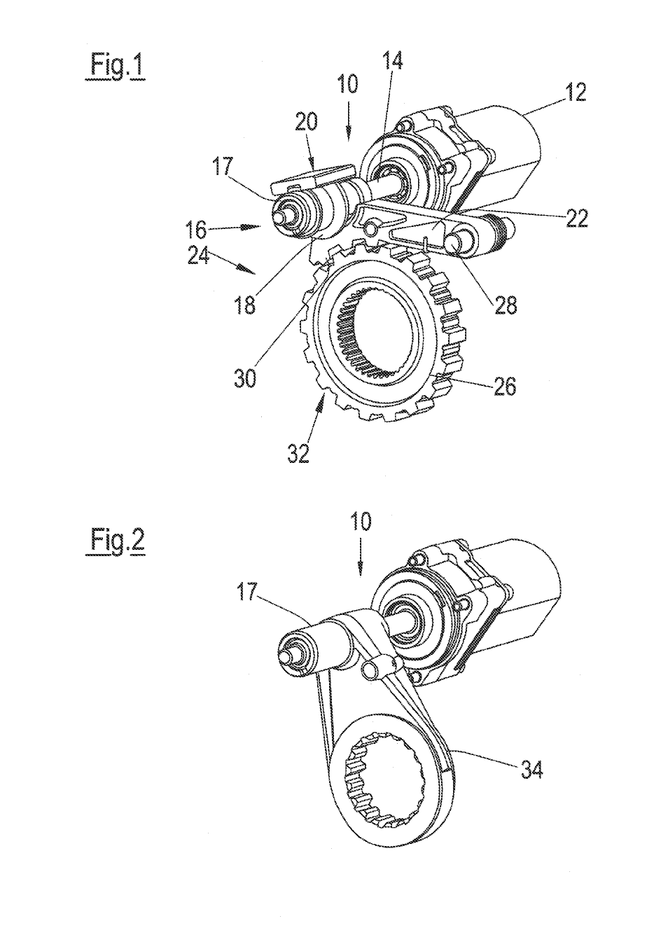

FIG. 1 illustrates an actuator 10 which includes a motor 12. The motor 12 sets a motor shaft 14 in a rotational motion. Such rotational motion is converted by a converter device 16 into a translatory movement of a guide sleeve 17 on which an actuator cone 18 is mounted. The actuator cone 18 is secured against rotation, and guided in its translatory movement, by a guide element 20. During an actuation the rotational movement of the motor shaft 14 is converted into a movement of the actuator cone 18 toward the motor 12. Such movement by the actuator cone 18 is converted by run-on bevels, which are formed on the actuator cone 18 and on a pawl 22, into an actuation movement of the pawl 22, that is to say the pawl 22 is pushed a downward direction.

The pawl 22 is part of a parking lock 24. The parking lock 24 also includes a ratchet wheel 26 which is connected in a rotationally conjoint manner to a gearbox shaft (not illustrated) arranged offset with respect to and parallel to the motor shaft 14. As already described, during an actuation, the pawl 22, which is mounted so as to be pivotable about a pawl pin 28, is pushed downward and latches with locking teeth 30 arranged thereon into correspondingly formed recesses 32 of the ratchet wheel 26.

To use the actuator 10 for actuating a unit which differs from the parking lock 24, the parking lock 24 may on the one hand be replaced by a functional unit which has a nut-on bevel compatible with/complementary to that of the actuator cone 18. If a run-on bevel on the functional unit to be actuated differs, the actuator cone 18 can be exchanged. It is basically also possible instead of the actuator cone 18 to provide a completely different element which generates coupling between the guide sleeve 17 and the functional unit to be actuated.

FIG. 2 illustrates the actuator 10 of FIG. 1, and therefore, a repeated detailed description of the actuator 10 is not necessary. Here, however, the guide sleeve 17 is not in contact with the actuator cone 18 but rather interacts directly with an actuating lever 34 of a clutch (not illustrated in any more detail). It is also possible for a shift fork of a shift gearbox, for example, to be provided instead of the actuating lever 34.

The actuator 10 is structurally identical in FIG. 1 and FIG. 2. The guide sleeve 17 serves as an output element which performs a translatory movement during an actuation. The actuator 10 can be converted in a simple manner in order to operate different functional units, illustrated here by way of example by a parking lock 24 and a clutch (not illustrated), which can be actuated by way of the described actuating movement. The gearboxes provided with the actuator 10, therefore, form a family. Here, the position of the actuator 10 relative to predefined components (individual components or assemblies) of the gearbox may be fixed in order to attain an even greater degree of standardization.

n the figures described above, the predefined component is, by way of example, a gearbox shaft which is to be secured against rotation in certain situations by the parking lock 24 of FIG. 1. In the configuration of FIG. 2, a clutch is provided in order to selectively connect the same gearbox shaft operatively in terms of drive to further gearbox components. Here, the axis-center distance between the motor shaft 14 and the gearbox shaft (not illustrated) which runs parallel to the motor shaft 14 is identical in FIG. 1 and FIG. 2. This feature duly increases the desired level of modularity but is basically not imperatively necessary, because different axis-center distances or axis orientations may be compensated by way of correspondingly designed actuation input elements of the functional units.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1-4. (canceled)

5. A family of vehicle gearboxes comprising:
a first vehicle gearbox having a first gearbox shaft and a first actuation system including:
a first guide sleeve;
a first actuator cone which is mounted on the first guide sleeve;
a first motor configured to set a first motor shaft in a rotational motion;
a first converter device configured to convert the rotational motion of the motor shaft into a translatory movement of the first guide sleeve; and
a guide element configured to secure the first actuator cone against rotation and also guide the translatory movement of the first actuator cone;
a second vehicle gearbox having a second gearbox shaft and a second actuation system including:
a second guide sleeve:
a second actuator cone which is mounted on the second guide sleeve;
a second motor configured to set a second motor shaft in a rotational motion; and
a second converter device configured to convert the rotational potion of the second motor shaft into a translatory movement of the second guide sleeve,
wherein during operation of the first actuation system and the second actuation system, respectively, the rotational movement of the first motor shaft and the second motor shaft, respectively, is converted into a movement of the first actuator cone and the second actuator cone, respectively, toward the first motor and the second motor, respectively.

6. The family of vehicle gearboxes of claim 14, wherein:
the first actuation system further comprises a first actuator shaft; and
the second actuation system further comprises a second actuator shaft.

7. The family of vehicle gearboxes of claim 6, wherein:
an axis-center distance between the first gearbox shaft and the first actuator shaft is identical to an axis-center distance between the second gearbox shaft and the second actuator shaft.

8. A family of vehicle gearboxes comprising:
a first vehicle gearbox having a first gearbox shaft and a first actuation system including:
a first guide sleeve;
a first actuator cone which is mounted on the first guide sleeve;
a first motor configured to set a first motor shaft in a rotational motion;
a first converter device configured to convert the rotational motion of the motor shaft into a translatory movement of the first guide sleeve; and
a guide element configured to secure the first actuator cone against rotation and also guide the translatory movement of the first actuator cone;
a second vehicle gearbox having a second gearbox shaft and a second actuation system including:
a second guide sleeve;
a second actuator cone which is mounted on the second guide sleeve;
a second motor configured to set a second motor shaft in a rotational motion; and
a second converter device configured to convert the rotational motion of the second motor shaft into a translatory movement of the second guide sleeve,
wherein the first actuation system is configured to actuate a parking lock and the second actuation system is configured to actuate a functional unit of the vehicle which differs from the parking lock.

9. The family of vehicle gearboxes of claim 8, wherein during operation of the first actuation system and the second actuation system, respectively, the rotational movement of the first motor shaft and the second motor shaft, respectively, is converted into a movement of the first actuator cone and the second actuator cone, respectively, toward the first motor and the second motor, respectively.

10. The family of vehicle gearboxes of claim 8, wherein the functional unit comprises a clutch.

11. The family of vehicle gearboxes of claim 8, wherein the parking lock comprises:
a pawl pin;
a pawl having a plurality of teeth, the pawl being mounted for pivotable movement about the pawl pin; and
a ratchet wheel having a plurality of teeth.

12. The family of vehicle gearboxes of claim 11, wherein movement of the first actuator cone is converted into an actuation movement of the pawl.

13. The family of vehicle gearboxes of claim 12, wherein the actuation movement of the pawl is in a downward direction.

14. The family of vehicle gearboxes of claim 13, wherein the teeth of the pawl latches with correspondingly formed recesses between the teeth of the ratchet wheel.

15. The family of vehicle gearboxes of claim 11, wherein the ratchet wheel is connected in a rotationally conjoint manner to the first gearbox shaft arranged offset with respect to and parallel to the first motor shaft.

16. The family of vehicle gearboxes of claim 8, wherein:
an output element of the first actuation system is configured to be compatible with an actuation input element of the parking lock; and
an output element of the second actuation system is configured to be compatible with an actuation input element of the functional unit.

17. The family of vehicle gearboxes of claim 8, wherein:
the first actuation system is arranged at a same position relative to at least one predetermined component of the first vehicle gearbox; and
the second actuation system is arranged at a same position relative to at least one predetermined component of the second vehicle gearbox.

18. A family of vehicle gearboxes comprising:
a first vehicle gearbox having a first gearbox shaft and a first actuation system is configured to actuate a parking lock, the first actuation system including:
a first guide sleeve;
a first actuator cone which is mounted on the first guide sleeve;
a first motor configured to set a first motor shaft in a rotational motion, wherein during operation of the first actuation system, he rotational movement of the first motor shaft is converted into movement of the first actuator cone in a direction toward the first motor;
a first converter device configured to convert the rotational motion of the motor shaft into a translatory movement of the first guide sleeve; and
a guide element configured to secure the first actuator cone against rotation and also guide the translatory movement of the first actuator cone,
a second vehicle gearbox having a second gearbox shaft and a second actuation configured to actuate a vehicle clutch, the second actuation system including:
a second guide sleeve;
a second actuator cone which is mounted on the second guide sleeve;
a second motor configured to set a second motor shaft in a rotational motion, wherein during operation of the second actuation system, the rotational movement of the second motor shaft is converted into movement of the second actuator cone in a direction toward the second motor; and
a second converter device configured to convert the rotational motion of the second motor shaft into a translatory movement of the second guide sleeve,
wherein the first actuation system is arranged at a same position relative to at least one predetermined component of the first vehicle gearbox, and the second actuation system is arranged at a same position relative to at least one predetermined component of the second vehicle gearbox.

19. The family of vehicle gearboxes of claim 18, wherein the parking lock comprises:
a pawl pin;
a pawl having a plurality of teeth, the pawl being mounted for pivotable movement about the pawl pin; and
a ratchet wheel having a plurality of teeth.

20. The family of vehicle gearboxes of claim 19, wherein movement of the first actuator cone is converted into an actuation movement of the pawl.

21. The family of vehicle gearboxes of claim 20, wherein the actuation movement of the pawl is in a downward direction.

22. The family of vehicle gearboxes of claim 21, wherein the teeth of the pawl latches with correspondingly formed recesses between the teeth of the ratchet wheel.

23. The family of vehicle gearboxes of claim 19, wherein the ratchet wheel is connected in a rotationally conjoint manner to the first gearbox shaft arranged offset with respect to and parallel to the first motor shaft.

24. The family of vehicle gearboxes of claim 18, wherein:
an output element of the first actuation system is configured to be compatible with an actuation input element of the parking lock; and
an output element of the second actuation system is configured to be compatible with an actuation input element of the functional unit.
